(19) United States
(12) Patent Application Publication
(10) Pub. No.: US 2013/0319639 A1
(43) Pub. Date: Dec. 5, 2013

(54) COOLING DEVICE AND METHOD FOR MAKING THE SAME

(71) Applicants: Hitoshi Sakamoto, Tokyo (JP); Minoru Yoshikawa, Tokyo (JP); Masaki Chiba, Tokyo (JP); Kenichi Inaba, Tokyo (JP); Arihiro Matsunaga, Tokyo (JP)

(72) Inventors: Hitoshi Sakamoto, Tokyo (JP); Minoru Yoshikawa, Tokyo (JP); Masaki Chiba, Tokyo (JP); Kenichi Inaba, Tokyo (JP); Arihiro Matsunaga, Tokyo (JP)

(73) Assignee: NEC CORPORATION, Tokyo (JP)

(21) Appl. No.: 14/000,681

(22) PCT Filed: Feb. 17, 2012
(86) PCT No.: PCT/JP2012/054488

§ 371 Date: Aug. 21, 2013

(30) Foreign Application Priority Data
Feb. 22, 2011 (JP) 2011-035938

(51) Int. Cl. F28D 15/00; B23P 15/26

(52) U.S. Cl. CPC F28D 15/00; B23P 15/26
USPC 165/104.29; 29/890.03

(57) ABSTRACT

In a cooling device using an ebullient cooling system, it is difficult to improve the cooling performance without increasing manufacturing costs, therefore, a cooling device according to an exemplary aspect of the invention includes a heat receiving unit storing a refrigerant and receiving the heat from an object to be cooled; a heat radiating unit radiating heat by condensing and liquefying a vapor-state refrigerant arising from a refrigerant vaporizing in the heat receiving unit; and a connection connecting the heat receiving unit to the heat radiating unit; wherein the heat receiving unit includes a base thermally contacting with the object to be cooled, and a container connected to the connection; the base includes a heat receiving unit outer wall composing a part of an outer wall of the heat receiving unit, and a plurality of projections disposed on a heat receiving unit undersurface of an undersurface at an inner wall side contacting with the refrigerant; the base includes a bubble nucleus forming surface on a refrigerant contacting surface composed of the heat receiving unit undersurface and the surface of the projection; and the heat receiving unit includes a vapor-state refrigerant region containing a vapor-state refrigerant between the top edge of the projection and one of inner wall surfaces of the container facing the heat receiving unit undersurface.

### TECHNICAL FIELD

The present invention relates to cooling devices for semiconductor devices and electronic apparatuses and, in particular, to a cooling device and a method for making the same using an ebullient cooling system in which heat transport and heat radiation are performed by a cycle of vaporization and condensation of a refrigerant.

### BACKGROUND ART

In recent years, with the progress of high performance and high functionality in semiconductor devices, electronic apparatuses and the like, the amount of heat generation from them has been also increasing. On the other hand, the miniaturization of semiconductor devices and electronic apparatus has been advancing due to the popularization of portable devices. Because of such background, a cooling device with high efficiency and a small size has been required. The cooling device using an ebullient cooling system in which heat transport and heat radiation are performed by a cycle of vaporization and condensation of a refrigerant, has been expected as a cooling device for semiconductor devices and electronic apparatuses and the like because it does not require any driving unit such as a pump.

An example of the cooling device using the ebullient cooling system (hereinafter, also denoted as an ebullient cooling device) is described in patent literature 1. The ebullient cooling device described in patent literature 1 includes a refrigerant tank pooling a refrigerant of liquid-state inside, and a heat radiation unit communicated with the inside of the refrigerant tank and fixed to the upper portion of the refrigerant tank. A heating element is placed outside the refrigerant tank, and the heat radiation unit condenses the refrigerant vaporized by the heat of the heating element and then returns it to the refrigerant tank again. Furthermore, a plurality of fins to expand a heating surface area and to accelerate the thermal diffusion is disposed on a boiling heat transfer surface formed together with a bottom wall of the refrigerant tank. It is configured that the height of the fin is 1.0 times or more to 3.4 times or less of a released air bubble diameter, and a fin pitch of the distance between two adjacent fins is set to 2 times or more of the released air bubble diameter. It is said that the above configuration makes it possible to accelerate the thermal diffusion of the heating element without making discharge property of air bubbles worse.

In patent literature 2, an ebullient cooling device is described which includes an evaporator storing a liquid-state refrigerant, a condenser condensing and liquefying the refrigerant steam and radiating the heat, and cuboids convex parts made of the same material member as a boiling surface on the boiling surface at the side of the inner wall in contact with the liquid-state refrigerant in the evaporator. And a blasting treatment is processed to be roughened using an abrasive material for all over the surface of the top surface and lateral surface of the convex parts and the flat surface other than the convex parts. It is said that, with all these factors, an ebullient cooling device with excellent cooling performance due to the improvement in the boiling heat-transfer coefficient can be obtained because it is possible to obtain an effect that the area to be processed by the blasting treatment increases and bubble nuclei increase.

Patent Literature 1: Japanese Patent Application Laid-Open Publication No. 2010-050326 (paragraphs [0026] to [0056])

Patent Literature 2: Japanese Patent Application Laid-Open Publication No. 2003-139476 (paragraphs [0023] to [0049])

### DISCLOSURE OF INVENTION

### Problem to be Solved by the Invention

In the above-mentioned ebullient cooling device described in patent literature 1, in order to hermetically seal the refrigerant tank and the heat radiation unit, it is necessary to mold them as a unit. For this reason, there has been a problem that an advanced manufacturing process is required and manufacturing costs increase. And there has been a problem that, if its miniaturization is intended in order to be used in electronic devices and the like, it becomes difficult to thermally separate the refrigerant tank from the heat radiation unit and to radiate the heat efficiently from the heat radiation unit to the outside.

In the above-mentioned ebullient cooling device described in patent literature 2, it is configured that the blasting treatment is processed for all over the surface of the boiling surface. For this reason, a process is required for protecting an undesirable area to be roughened by means of covering the surface partially (a masking process), therefore, there has been a problem that manufacturing costs increase.

As mentioned above, the related ebullient cooling devices have a problem that it is difficult to improve the cooling performance without increasing manufacturing costs.

The object of the present invention is to provide a cooling device and a method for making the same which solve the problem mentioned above that in a cooling device using an ebullient cooling system, it is difficult to improve the cooling performance without increasing manufacturing costs.

### Means for Solving a Problem

A cooling device according to an exemplary aspect of the invention includes a heat receiving unit storing a refrigerant and receiving the heat from an object to be cooled; a heat radiating unit radiating heat by condensing and liquefying a vapor-state refrigerant arising from a refrigerant vaporizing in the heat receiving unit; and a connection connecting the heat receiving unit to the heat radiating unit; wherein the heat receiving unit includes a base thermally contacting with the object to be cooled, and a container connected to the connection; the base includes a heat receiving unit outer wall composing a part of an outer wall of the heat receiving unit, and a plurality of projections disposed on a heat receiving unit undersurface of an undersurface at an inner wall side contacting with the refrigerant; the base includes a bubble nucleus forming surface on a refrigerant contacting surface composed of the heat receiving unit undersurface and the surface of the projection; and the heat receiving unit includes a vapor-state refrigerant region containing a vapor-state refrigerant between the top edge of the projection and one of inner wall surfaces of the container facing the heat receiving unit undersurface.

A method for making a cooling device according to an exemplary aspect of the invention includes the steps of: forming a base including a heat receiving unit outer wall composing a part of an outer wall of a heat receiving unit storing a refrigerant and receiving the heat from an object to be cooled, and a plurality of projections disposed on a heat receiving unit undersurface of an undersurface at an inner wall side contacting with the refrigerant; forming a bubble nucleus forming surface on a refrigerant contacting surface composed of the heat receiving unit undersurface and the surface of the projection; forming the heat receiving unit by joining a container covering the base to the base; connecting the heat receiving unit to a heat radiating unit radiating heat by condensing and liquefying a vapor-state refrigerant arising from a refrigerant vaporizing in the heat receiving unit; and forming a vapor-state refrigerant region containing the vapor-state refrigerant between a top edge of the projection and a bottom face of the container by injecting the refrigerant into the heat receiving unit.

### Effect of the Invention

According to the cooling device and the method for making the same of the present invention, it is possible to obtain a cooling device with an ebullient cooling system whose cooling performance is improved without increasing manufacturing costs.

### BRIEF DESCRIPTION OF THE DRAWINGS

FIG. 1 is a cross-sectional view illustrating a configuration of a cooling device in accordance with the first exemplary embodiment of the present invention.

FIG. 2A is a plan view illustrating a configuration of a base of a cooling device in accordance with the first exemplary embodiment of the present invention.

FIG. 2B is a side view illustrating a configuration of a base of a cooling device in accordance with the first exemplary embodiment of the present invention.

FIG. 3 is a schematic cross-sectional view to illustrate a method for making a cooling device in accordance with the first exemplary embodiment of the present invention.

FIG. 4 is an elevation view illustrating a configuration of a cooling device in accordance with the second exemplary embodiment of the present invention.

FIG. 5 is a cross-sectional view illustrating a configuration of a heat receiving unit in a cooling device in accordance with the second exemplary embodiment of the present invention.

FIG. 6 is a schematic cross-sectional view to illustrate a method for making a cooling device in accordance with the second exemplary embodiment of the present invention.

FIG. 7A is a vertical cross-sectional view to illustrate another configuration of a heat receiving unit in a cooling device in accordance with the second exemplary embodiment of the present invention.

FIG. 7B is a horizontal cross-sectional view to illustrate another configuration of a heat receiving unit in a cooling device in accordance with the second exemplary embodiment of the present invention.

### DESCRIPTION OF EMBODIMENTS

The exemplary embodiments of the present invention will be described with reference to drawings below.

### The First Exemplary Embodiment

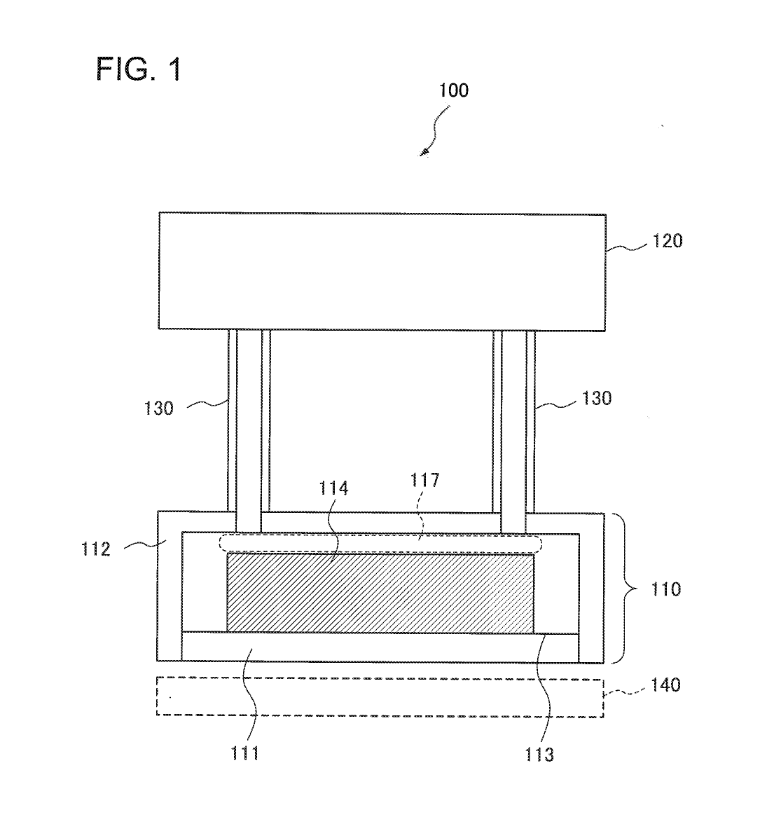

FIG. 1 is a cross-sectional view illustrating a configuration of a cooling device 100 in accordance with the first exemplary embodiment of the present invention. The cooling device 100 in the present exemplary embodiment includes a heat receiving unit 110 storing a refrigerant and receiving the heat from an object to be cooled, a heat radiating unit 120 radiating heat by condensing and liquefying a vapor-state refrigerant arising from a refrigerant vaporizing, and a connection 130 connecting the heat receiving unit 110 to the heat radiating unit 120.

The heat receiving unit 110 includes a base 111 thermally contacting with an object to be cooled 140, and a container 112 connected to the connection 130. The base 111 includes a plurality of projections 114 on a heat receiving unit undersurface 113 of an undersurface at an inner wall side contacting with the refrigerant. The base 111 and the container 112 are joined by a joining means interposing metallic members such as welding or brazing and the like to form a sealed structure, which stores the refrigerant inside it. The connection 130 is connected to the container 112, and the refrigerant circulates in a vapor- state or liquid-state between the heat receiving unit 110 and the heat radiating unit 120 through the connection 130.

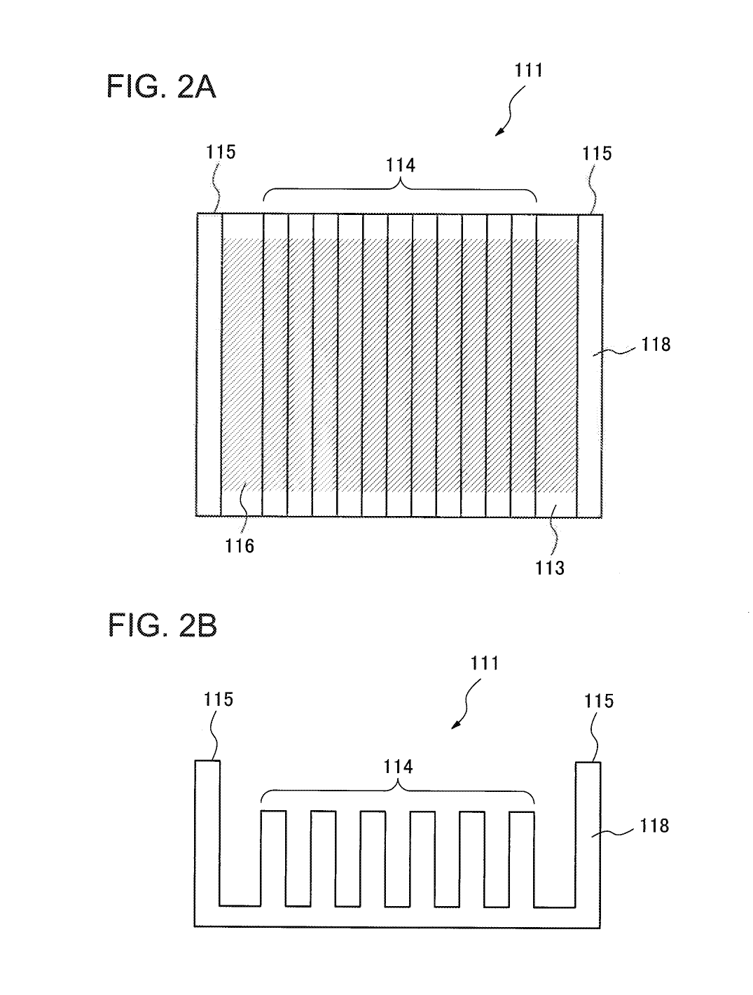

FIG. 2A and FIG. 2B show a configuration of the base 111 in the heat receiving unit 110 according to the present exemplary embodiment. FIG. 2A is a plan view, and FIG. 2B is a side view. As shown in the figures, the base 111 includes a heat receiving unit outer wall 115 composing a part of an outer wall of the heat receiving unit 110 at both ends in one direction, and a plurality of projections 114 are disposed on the heat receiving unit undersurface 113. And the base 111 includes a bubble nucleus forming surface 116 on a refrigerant contacting surface composed of at least a part of the heat receiving unit undersurface 113 (the shaded area in FIG. 2A) and the surface of the projection 114.

The refrigerant is enclosed in the heat receiving unit 110, and by means of evacuation, the inside of the heat receiving unit 110 is always maintained in the saturated vapor pressure of the refrigerant, and the boiling point of the refrigerant becomes equal to normal temperature. Therefore, when the object to be cooled 140 produces heat and heat quantity is transferred to the refrigerant through the base 111, the refrigerant is vaporized and bubbles arise. At that time, since the heat quantity from the object to be cooled 140 is taken away as vaporization heat by the refrigerant, it is possible to avoid rise in temperature of the object to be cooled 140. Here, as shown in FIG. 1, the heat receiving unit 110 of the present exemplary embodiment includes a vapor-state refrigerant region 117 containing a vapor-state refrigerant between the top edge of the projection 114 and the bottom face of the container 112. That is to say, it includes the vapor-state refrigerant region 117 containing a vapor-state refrigerant between the top edge of the projection 114 and one of inner wall surfaces of the container 112 which faces the heat receiving unit undersurface 113.

The refrigerant vaporized in the heat receiving unit 110 flows through the connection 130 and is cooled, condensed and liquefied in the heat radiating unit 120, and the refrigerant in liquid-state flows again into the heat receiving unit 110 through the connection 130. It is possible for the cooling device 100 to cool the object to be cooled 140 by the foregoing circulation of the refrigerant without using a driving unit such as a pump.

As mentioned above, the cooling device 100 of the present exemplary embodiment has the configuration in which the heat receiving unit 110 is connected to the heat radiating unit 120 through the connection 130. It becomes possible, therefore, to optimally design and manufacture the heat receiving unit 110 and the heat radiating unit 120 separately. Accordingly, it becomes possible to make the heat receiving unit 110 only respond to the downsizing of the object to be cooled 140 such as an electronic device. As a result, it is possible to improve the cooling performance without increasing manufacturing costs.

The heat receiving unit 110 of the present exemplary embodiment includes the projections 114 on the heat receiving unit undersurface 113 in the base 111. The projection 114 can be formed in the fin geometry, for example, and it has the effect to enhance the convection and the circulation of the refrigerant. Here, as the material of the base 111 and the projection 114, it is possible to use the metal having an excellent thermal conductive property such as aluminum.

The heat receiving unit 110 according to the present exemplary embodiment includes the bubble nucleus forming surface 116 on the refrigerant contacting surface composed of the heat receiving unit undersurface 113 and the surface of the projection 114 (see FIG. 2A). Since a plurality of bubble nuclei, each of which becomes a source nucleus for the bubbles of the refrigerant, are formed on the bubble nucleus forming surface 116, the generation of the bubbles is enhanced and the cooling performance is improved due to the vaporization of the refrigerant. In addition, because the circulation of the refrigerant is enhanced by the projection 114 provided for the heat receiving unit 110, it is possible to efficiently eject the bubbles and the vapor-state refrigerant to the heat radiating unit 120.

Each of the bubble nuclei has a concavo-convex shape with a projection and a hollow, and the optimum value of the size of the concavo-convex shape is determined by considering physical properties such as surface tension of the refrigerant. For example, if a refrigerant is used whose surface tension is in a range from 0.010 N/m to 0.020 N/m, the optimum size of the bubble nucleus is in the range of sub-micron to tens of micrometers in center line average roughness. Therefore, it is possible to form the bubble nuclei by a mechanical processing using abrasive grains, a sandblast, and the like, or by a chemical processing such as an etching or a plating. FIG. 2A illustrates a case that the bubble nucleus forming surface 116 is disposed on the refrigerant contacting surface composed of the heat receiving unit undersurface 113 except edge areas (the shaded area in the figure) and the surface of the projection 114. It is possible to use specifically, as the refrigerant, hydrofluorocarbon, hydrofluoroether, and the like, which are insulating and inactive materials.

The heat receiving unit 110 of the present exemplary embodiment includes the sealed structure in which the base 111 and the container 112 are joined by a joining means interposing metallic members such as brazing and the like. The vapor-state refrigerant region 117 containing a vapor-state refrigerant is included between the top edge of the projection 114 and the bottom face of the container 112. That is to say, the heat receiving unit outer wall 115 is formed whose height is higher than that of the projection 114, and a space is formed above the projection 114 due to the difference between their heights. Because bubbles are ejected into the space, the vapor-state refrigerant region 117 is formed. Since the space composing the vapor-state refrigerant region 117 is formed, the ejection of bubbles is enhanced, and therefore, it is possible to improve the cooling performance in the heat receiving unit 110 of the present exemplary embodiment. At this time, it is possible for the height of the heat receiving unit outer wall 115 to be equal to or more than 1.05 times and equal to or less than 3.0 times that of the projection 114. The lower limit is a value which is determined by configuring the vapor-state refrigerant region 117 with the minimum thickness, and the upper limit is a value which is determined by the configuration in which the vapor-state refrigerant is not condensed and liquefied again inside the heat receiving unit 110.

Next, the method for making the cooling device 100 according to the present exemplary embodiment will be described. First, as shown in FIG. 2A and FIG. 2B, the base 111 is produced by forming the heat receiving unit outer wall 115 composing a part of the outer wall of the heat receiving unit and a plurality of projections 114 on the heat receiving unit undersurface 113 which is an undersurface in the inner-wall side in contact with the refrigerant. To make the base 111, the extrusion processing can be employed, for example. It is not limited to this, however, the cutting processing may be employed, and it is also acceptable to make a member composing the projection separately and then attach it to the heat receiving unit undersurface 113. At this time, the base 111 is formed so that the height of the heat receiving unit outer wall 115 may become higher than that of the projection 114. As a result, a space is formed above the projection 114 due to the difference between their heights, and it is possible to configure the vapor-state refrigerant region 117.

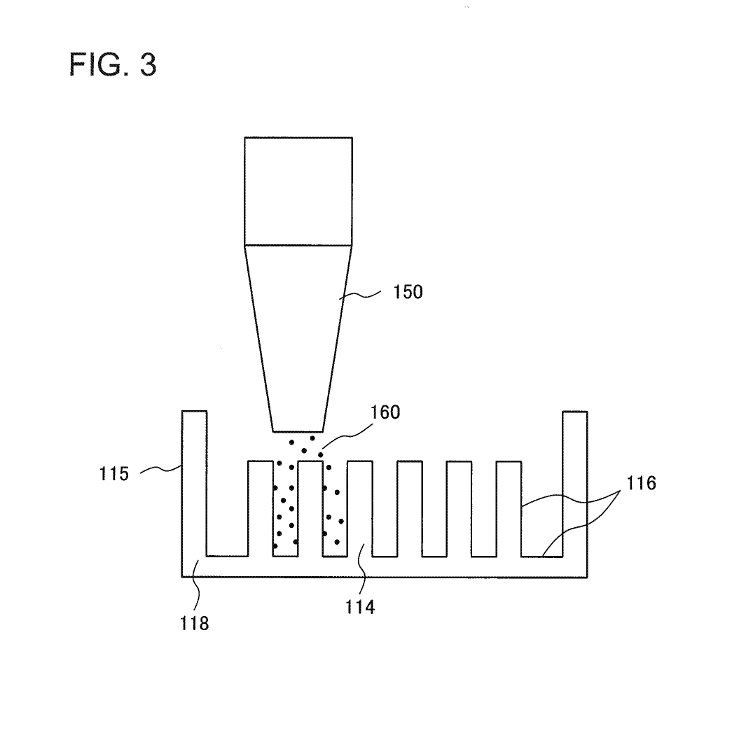

Next, the bubble nucleus forming surface 116 is formed on the refrigerant contacting surface composed of the heat receiving unit undersurface 113 and the surface of the projection 114. To form the bubble nucleus forming surface 116, it is possible to employ a surface roughening process using a nozzle blasting process, as shown in FIG. 3. The nozzle blasting process is a process of performing a roughening treatment by spraying abrasive particles (blast material) from a minute spray nozzle and bombarding a processing surface. In the present exemplary embodiment, the bubble nucleus forming surface 116 is formed by disposing the tip of a spray nozzle 150 between the top edge of the projection 114 and the top edge of the heat receiving unit outer wall 115, and spraying abrasive particles 160 from the spray nozzle 150. Here, the base 111 is used which is formed so that the height of the heat receiving unit outer wall 115 may become equal to or more than 1.1 times and equal to or less than 3.0 times that of the projection 114. The lower limit is a value which is determined by disposing the tip of the spray nozzle 150 between the top edge of the projection 114 and the top edge of the heat receiving unit outer wall 115, and the upper limit is a value which is determined by the configuration in which the vapor-state refrigerant is not condensed and liquefied again inside the heat receiving unit 110.

In this way, by disposing the tip of the spray nozzle 150 on the lower side of the top edge of the heat receiving unit outer wall 115 and performing the nozzle blasting process, it becomes possible to prevent scatter of abrasive particles. Accordingly, it is possible to form the bubble nucleus forming surface 116 only on the refrigerant contacting surface composed of the heat receiving unit undersurface 113 and the surface of the projection 114.

Subsequently, the heat receiving unit 110 is formed by joining the container 112 covering the base 111 to the base 111. As shown in FIG. 2A and FIG. 2B, the formation process of the heat receiving unit 110 is performed by joining the base 111 to the container 112 at a joint surface 118 including the upper surface and the side surface of the base 111 by using a joining means interposing metallic members such as welding or brazing and the like. At this time, according to the method for making the cooling device 100 of the present exemplary embodiment, since scatter of abrasive particles is prevented in the process for forming the bubble nucleus forming surface 116, a bubble nucleus forming surface is not formed on the joint surface 118. Thus, it becomes possible to obtain a good joint. Accordingly, in the process for forming the bubble nucleus forming surface 116, it becomes unnecessary to perform a process for covering and protecting the joint surface 118 (a masking process) for the purpose of preventing the joint surface 118 from roughening. As a result, it is possible to avoid the increase in manufacturing costs due to the increase in manufacturing processes.

FIG. 2A and FIG. 2B show a case where the base 111 includes, at both ends in one direction, the heat receiving unit outer wall 115 composing a part of the outer wall of the heat receiving unit 110. However, it is not limited to this, it is also acceptable for the base 111 to include the heat receiving unit outer wall 115 at each end of four sides. In this case, it is possible to configure the container 112 so as to cover only the upper surface of the base 111.

Next, the heat receiving unit 110 is connected to the heat radiating unit 120 by the connection 130. Finally, a refrigerant is injected into the heat receiving unit 110, and the vapor-state refrigerant region 117 containing a vapor-state refrigerant is formed between the top edge of the projection 114 and the bottom face of the container 112, and consequently, the cooling device 100 according to the present exemplary embodiment is completed.

As mentioned above, the cooling device according to the present exemplary embodiment has a configuration in which the heat receiving unit 110 is connected to the heat radiating unit 120 through the connection 130, therefore, it is possible to make the heat receiving unit only respond to the downsizing of a object to be cooled such as an electronic device, and a radiation efficiency in the heat radiation unit is not deteriorated. Moreover, since a space composing the vapor-state refrigerant region is formed, the ejection of bubbles is enhanced, and therefore, it is possible to improve the cooling performance in the heat receiving unit. According to the method for making the cooling device of the present exemplary embodiment, since the scatter of abrasive particles is prevented in the process for forming the bubble nucleus forming surface, it becomes unnecessary to perform a process for covering and protecting the joint surface (a masking process). Thus, according to the cooling device and the method for making the same of the present exemplary embodiment, it is possible to obtain a cooling device with an ebullient cooling system whose cooling performance is improved without increasing manufacturing costs.

### The Second Exemplary Embodiment

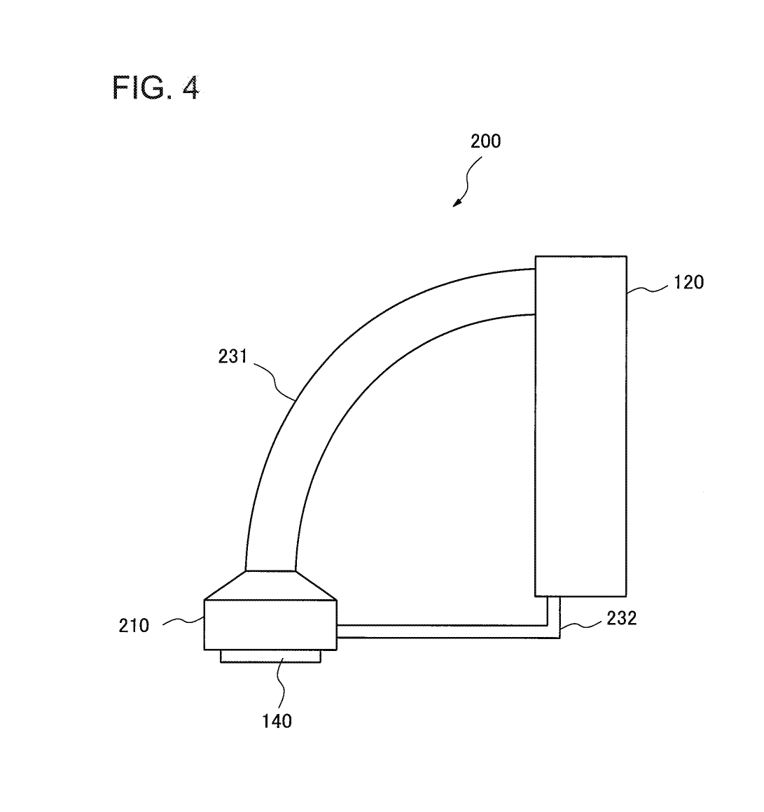

Next, the second exemplary embodiment of the present invention will be described. FIG. 4 is an elevation view illustrating a configuration of a cooling device 200 in accordance with the second exemplary embodiment of the present invention. The cooling device 200 of the present exemplary embodiment includes a heat receiving unit 210 storing a refrigerant and receiving the heat from an object to be cooled, a heat radiating unit 120 radiating heat by condensing and liquefying a vapor-state refrigerant arising from a refrigerant vaporizing, and a connection connecting the heat receiving unit 110 to the heat radiating unit 120.

The cooling device 200 of the present exemplary embodiment is different from the cooling device 100 of the first exemplary embodiment in the configuration of the heat receiving unit 210 and the connection. That is to say, in the cooling device 200 of the present exemplary embodiment, the connection is configured to include a first connection 231 transporting a vapor-state refrigerant from the heat receiving unit 210 to the heat radiating unit 120, and a second connection 232 transporting a liquid-state refrigerant condensed and liquefied in the heat radiating unit 120 from the heat radiating unit 120 to the heat receiving unit 210. And the heat receiving unit 210 includes a junction connected to each of the connections. The other configurations are the same as those in the first exemplary embodiment, and therefore, the descriptions are omitted.

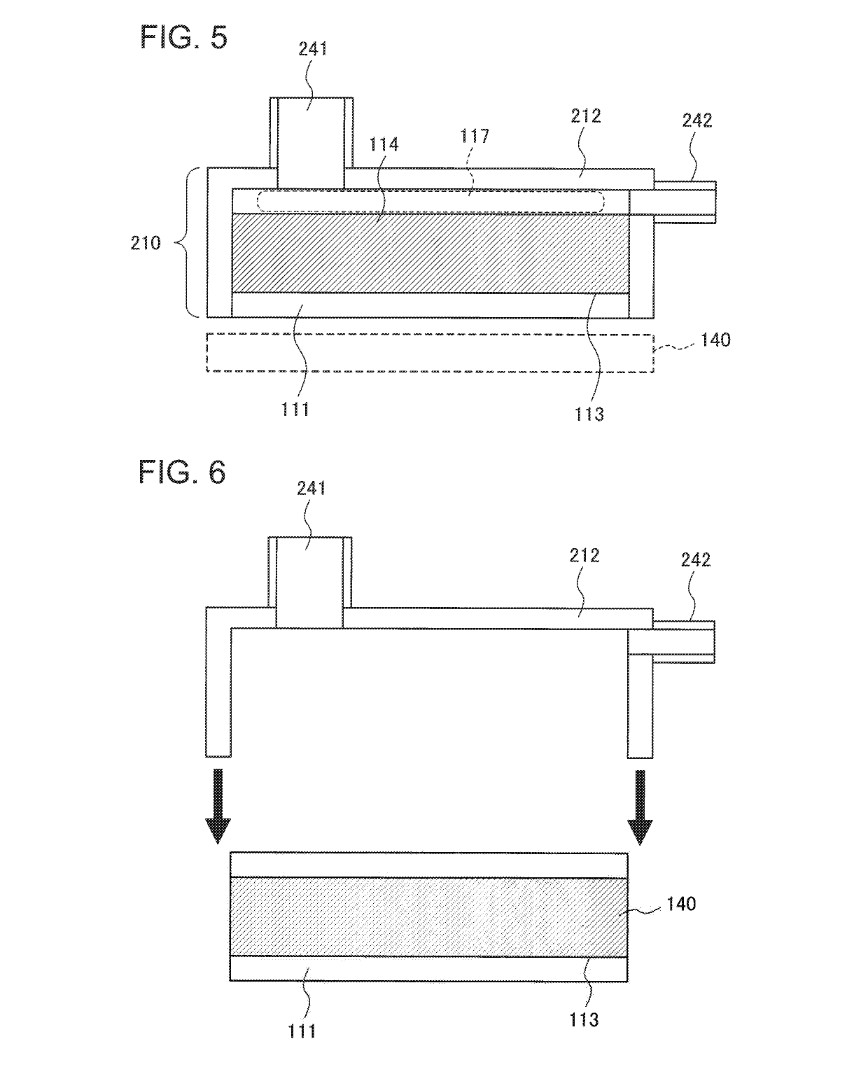

FIG. 5 is a cross-sectional view illustrating a configuration of the heat receiving unit 210 in accordance with the present exemplary embodiment. The heat receiving unit 210 includes a base 111 thermally contacting with an object to be cooled 140, and a container 212 connected to the first connection 231 and the second connection 232. The base 111 includes a plurality of projections 114 on a heat receiving unit undersurface 113 of an undersurface at an inner wall side contacting with the refrigerant. The base 111 and the container 212 are joined by a joining means interposing metallic members such as welding or brazing and the like to form a sealed structure, which stores the refrigerant inside it.

The container 212 of the present exemplary embodiment includes a first junction 241, connected to the first connection 231, on the upper surface of the container 212, and a second junction 242, connected to the second connection 232, on one of side surfaces of the container 212. And the refrigerant circulates in a vapor-state or liquid-state between the heat receiving unit 210 and the heat radiating unit 120 through the first connection 231 and the second connection 232.

At this time, in the heat receiving unit 210 of the present exemplary embodiment, the second junction 242 is disposed at a position equal to or higher than the height of the projection 114 above the heat receiving unit undersurface 113. As a result, even though the projections 114 are formed from one end through the other end of the base 111 as shown in FIG. 5, the liquid-state refrigerant is efficiently injected from the second junction 242 without being interrupted by the projections 114. Accordingly, it becomes possible to utilize the cooling effect to the full by means of the projection 114 without interrupting the circulation of the refrigerant. As a result, according to the cooling device 200 of the present exemplary embodiment, it is possible to obtain a cooling device with an ebullient cooling system whose cooling performance is further improved.

The liquid-state refrigerant injected from the second junction 242 into the inside of the heat receiving unit 210 spreads so that it may cover the heat receiving unit undersurface 113 facing the object to be cooled 140. At this time, in addition to endothermic workings due to the convection of the liquid-state refrigerant, it is possible to obtain a superior cooling effect by utilizing the vaporization heat of the liquid-state refrigerant due to the boil of the liquid-state refrigerant. As a result, it is possible to avoid rise in temperature of the object to be cooled 140 such as a heater element. Since the liquid-state refrigerant flows along not only the heat receiving unit undersurface 113 but also the projection 114, an endothermic reaction is also performed on the surfaces of the projection 114. In addition, bubbles, arising near the heat receiving unit undersurface 113, rise due to its buoyancy toward the first junction 241 disposed on the upper surface of the container 212. At this time, since the liquid-state refrigerant flows among the projections 114, the convection heat transfer is generated, and therefore, the endothermic workings are further enhanced. Taking into consideration the flow of the liquid-state refrigerant inside the heat receiving unit 210, it is preferable that the projection 114 is configured as a plate-like fin in order to further enhance the cooling effect.

It is possible to produce the cooling device 200 of the present exemplary embodiment by using a similar making method to the above-mentioned method for the cooling device 100 of the first exemplary embodiment. For example, it is possible to form the projection 114 from one end through the other end of the base 111 by using the extrusion processing. As shown in FIG. 6, the heat receiving unit 210 is formed by joining the container 212 covering the base 111 to the base 111. In this case, as shown in FIG. 2A and FIG. 2B, according to the method for making a cooling device of the present exemplary embodiment, a bubble nucleus forming surface is not formed on the joint surface 118. Accordingly, in the process for forming the bubble nucleus forming surface 116, it becomes possible to obtain a good joint without performing a process for covering and protecting the joint surface 118 (a masking process).

Thus, according to the cooling device and the method for making the same of the present exemplary embodiment, it is possible to obtain a cooling device with an ebullient cooling system whose cooling performance is improved without increasing manufacturing costs.

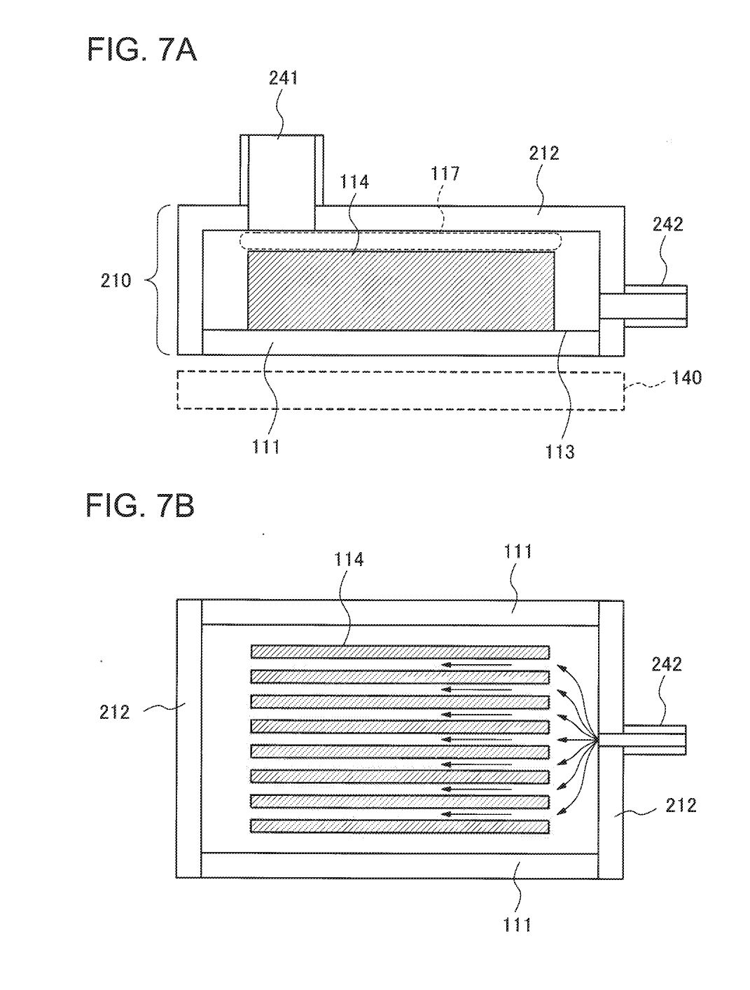

In the above description, it is configured that the second junction 242 is disposed at a position equal to or higher than the height of the projection 114 above the heat receiving unit undersurface 113. It is not limited to this, however, as shown in FIG. 7A, it is also acceptable to be configured that the second junction 242 is disposed near the heat receiving unit undersurface 113. In this case, by adopting a configuration including a branching unit (a manifold) in the second junction 242, it is possible to efficiently inject the liquid-state refrigerant into spaces among the projections 114, as shown in FIG. 7B.

The present invention is not limited to the above-mentioned exemplary embodiments and can be variously modified within the scope of the invention described in the claims. It goes without saying that these modifications are also included in the scope of the present invention.

This application is based upon and claims the benefit of priority from Japanese Patent Application No. 2011-035938, filed on Feb. 22, 2011, the disclosure of which is incorporated herein in its entirety by reference.

### DESCRIPTION OF THE CODES

100, 200 cooling device
110, 210 heat receiving unit
111 base
112, 212 container
113 heat receiving unit undersurface
114 projections
115 receiving-heat-unit outer wall portion
116 bubble nucleus forming surface
117 vapor-state refrigerant region
118 joint surface
120 heat radiating unit
130 connection
140 object to be cooled
150 spray nozzle
160 abrasive particles
231 first connection
232 second connection
241 first junction
242 second junction

1. A cooling device, comprising:
a heat receiving unit storing a refrigerant and receiving the heat from an object to be cooled;
a heat radiating unit radiating heat by condensing and liquefying a vapor-state refrigerant arising from a refrigerant vaporizing in the heat receiving unit; and
a connection connecting the heat receiving unit to the heat radiating unit;
wherein the heat receiving unit comprises a base thermally contacting with the object to be cooled, and a container connected to the connection;
the base comprises a heat receiving unit outer wall composing a part of an outer wall of the heat receiving unit, and a plurality of projections disposed on a heat receiving unit undersurface of an undersurface at an inner wall side contacting with the refrigerant;
the base comprises a bubble nucleus forming surface on a refrigerant contacting surface composed of the heat receiving unit undersurface and the surface of the projection; and
the heat receiving unit comprises a vapor-state refrigerant region containing a vapor-state refrigerant between the top edge of the projection and one of inner wall surfaces of the container facing the heat receiving unit undersurface.

2. The cooling device according to claim 1,
wherein the height of the heat receiving unit outer wall is equal to or more than 1.05 times and equal to or less than 3.0 times the height of the projection.

3. The cooling device according to claim 1,
wherein the height of the heat receiving unit outer wall is equal to or more than 1.1 times and equal to or less than 3.0 times the height of the projection.

4. The cooling device according to claim 1,
wherein the base is joined to the container interposing a metallic member at a joint surface including an upper surface and a side surface of the base.

5. The cooling device according to claim 1,
wherein the connection comprises a first connection transporting a vapor-state refrigerant from the heat receiving unit to the heat radiating unit, and a second connection transporting a liquid-state refrigerant condensed and liquefied in the heat radiating unit from the heat radiating unit to the heat receiving unit; and
the container comprises a first junction, connected to the first connection, on an upper surface of the container, and a second junction, connected to the second connection, on one of side surfaces of the container.

6. The cooling device according to claim 5,
wherein the second junction is disposed at a position equal to or higher than a height of the projection above the heat receiving unit undersurface.

7. The cooling device according to claim 5,
wherein the second junction is disposed near the heat receiving unit undersurface, and the second junction comprises a branching unit.

8. A method for making a cooling device, comprising the steps of:
forming a base comprising a heat receiving unit outer wall composing a part of an outer wall of a heat receiving unit storing a refrigerant and receiving the heat from an object to be cooled, and a plurality of projections disposed on a heat receiving unit undersurface of an undersurface at an inner wall side contacting with the refrigerant;
forming a bubble nucleus forming surface on a refrigerant contacting surface composed of the heat receiving unit undersurface and the surface of the projection;
forming the heat receiving unit by joining a container covering the base to the base;
connecting the heat receiving unit to a heat radiating unit radiating heat by condensing and liquefying a vapor-state refrigerant arising from a refrigerant vaporizing in the heat receiving unit; and
forming a vapor-state refrigerant region containing the vapor-state refrigerant between a top edge of the projection and a bottom face of the container by injecting the refrigerant into the heat receiving unit.

9. The method for making the cooling device according to claim 8,
wherein the base is formed so that the height of the heat receiving unit outer wall may be equal to or more than 1.1 times and equal to or less than 3.0 times the height of the projection; and
the bubble nucleus forming surface is formed by disposing a tip of a spray nozzle between a top edge of the projection and a top edge of the heat receiving unit outer wall, and spraying abrasive particles from the spray nozzle.

10. The method for making the cooling device according to claim 8,
wherein the heat receiving unit is formed by joining, interposing a metallic member, the container to a joint surface comprising a side surface of the base and a top edge of the heat receiving unit outer wall, on which the bubble nucleus forming surface is not formed.
